(19) United States
(12) Patent Application Publication
(10) Pub. No.: US 2014/0095286 A1
(43) Pub. Date: Apr. 3, 2014

(54) Private Third Party Validation of Hardware Identification for Offer Enrollment

(71) Applicant: GOOGLE INC., Mountain View, CA (US)

(72) Inventors: William Alexander Drewry, Nashville, TN (US); Gaurav Shah, San Jose, CA (US); Sumit Gwalani, Sunnyvale, CA (US)

(73) Assignee: GOOGLE INC., Mountain View, CA (US)

(21) Appl. No.: 13/632,901

(22) Filed: Oct. 1, 2012

(51) Int. Cl. G06Q 30/02

(52) U.S. Cl. 705/14.26

(57) ABSTRACT

Systems and methods are described herein for validating computer hardware identification information. A validation server can receive a request from an offer provider to validate an instance of computer hardware for enrollment in an offer. The offer may be associated with a service identifier. The validation server can request a hardware identification code from the instance of computer hardware. The validation server can receive the hardware identification code from the instance of computer hardware. The validation server can validate that the hardware identification code is eligible to enroll in the offer associated with the service identifier and then transmit a response to the offer provider indicating the validated status while maintaining privacy of the hardware identification code away from the offer provider.

### TECHNICAL FIELD

The present disclosure relates to systems and methods for enabling third party validation of hardware identification information, and, more particularly, to hardware identification information validation to verify offer eligibility.

### BACKGROUND

Certain computers or other computing devices may have some type of hardware identifier embedded within them. One example application for such hardware identifiers may include binding a software license or key to a particular hardware identifier such that the associated software license will be prevented from operating on other hardware that does not match the hardware identifier bound to the license. Other security related applications of hardware identifiers have been proposed. Unfortunately, there is a need in the art to address potential privacy concerns in the use of hardware identifiers.

Users may not wish to have a hardware identifier that is permanently associated with their computer transmitted to, and then possibly tracked by, other systems. Users generally wish to balance security with privacy and may fear that the loss of privacy inherent in widespread sharing of hardware identifiers may not be worth the added security of affirmatively tying transactions to a specific computer system.

### SUMMARY

In certain example embodiments described herein, methods and systems can validate computer hardware identification information. A validation server can receive a request from an offer provider to validate an instance of computer hardware for enrollment in an offer. The offer may be associated with a service identifier. The validation server can request a hardware identification code from the instance of computer hardware. The validation server can receive the hardware identification code from the instance of computer hardware. The validation server can validate that the hardware identification code is eligible to enroll in the offer associated with the service identifier and then transmit a response to the offer provider indicating the validated status while maintaining privacy of the hardware identification code away from the offer provider.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for privately validating hardware identification through a third party in accordance with one or more embodiments presented herein.

FIG. 2 is a block diagram depicting message structures used for private third party hardware identity validation in accordance with one or more embodiments presented herein.

FIG. 3 is a block flow diagram depicting a method for private third party validation of hardware identification in accordance with one or more embodiments presented herein.

FIG. 4 is a block diagram depicting a computing machine and a module in accordance with one or more embodiments presented herein.

### DETAILED DESCRIPTION OF EXAMPLE EMBODIMENTS

### Overview

The methods and systems described herein enable validating hardware identification information through a third party for enrollment in an offer for good or services. Validation through a third party can prevent an offer provider from obtaining hardware identifiers and then possibly tracking the use of the hardware or engaging in other exploitations of privacy associated with the hardware.

A user associated with a piece of hardware may initiate redemption or offer enrollment by indicating to the offer provider interest in redeeming or enrolling in an offer. The enrollment initiation may be redirected from the offer provider to a hardware attestation server. The hardware attestation server can then act as a third party to request hardware identification information from the user hardware to be validated.

When the hardware attestation server seeks to obtain the hardware identification information from the user hardware for validation, the user of the user hardware may be prompted for permission to share hardware identification information with the hardware attestation server. With the permission of the user, the hardware identification information may be transmitted to the hardware attestation server. This hardware identification information associated with the user hardware may include a unique identifier, a group identifier, or other such identification information. A zero-knowledge protocol may be used to assert to the hardware attestation server that the user hardware is within a specified group.

In response to receiving the hardware identification information, the hardware attestation server can determine if that hardware qualified for the offer requested and if there are enough offers remaining. Once the offer validation is determined, the hardware attestation server can prepare a response to the offer provider indicating positive or negative validation. If the offer provider receives a positive validation, the requested enrollment of the user hardware may be completed. An additional check may take place from the offer provider to the hardware attestation server may be performed to reduce man in the middle attacks.

The functionality of the various example embodiments will be explained in more detail in the following description, read in conjunction with the figures illustrating the program flow.

Turning now to the drawings, in which like numerals indicate like (but not necessarily identical) elements throughout the figures, example embodiments are described in detail.

### System Architecture

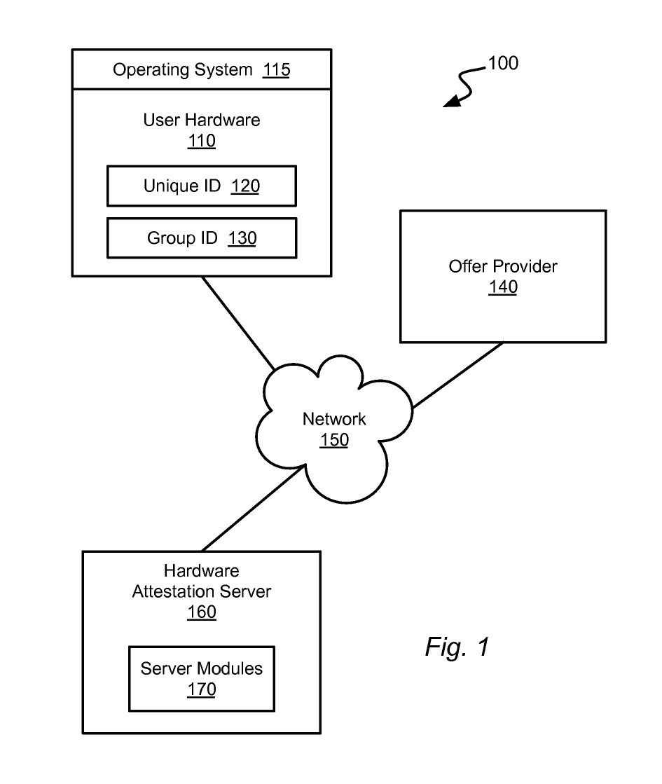

FIG. 1 is a block diagram depicting a system 100 for privately validating hardware identification through a third party in accordance with one or more embodiments presented herein. The user hardware 110 may incorporate any type of computer hardware such as a laptop, workstation, mobile device, or so forth. The user hardware 110 may incorporate hardware identification information such as the unique identifier 120, the group identifier 130, or other such identification information. The user hardware 110 may incorporate or be associated with an operating system 115. A user associated with the user hardware 110 may initiate enrollment in, or attempt to redeem, an offer associated with the offer provider 140. Without having to obtain the hardware identification information of the user hardware 110, the offer provider 140 may request the third party hardware attestation server 160 to validate the hardware identification information of the user hardware 110 on its behalf. The hardware attestation server may execute or leverage server modules 170 to perform third party hardware identifier validation functionality as discussed herein.

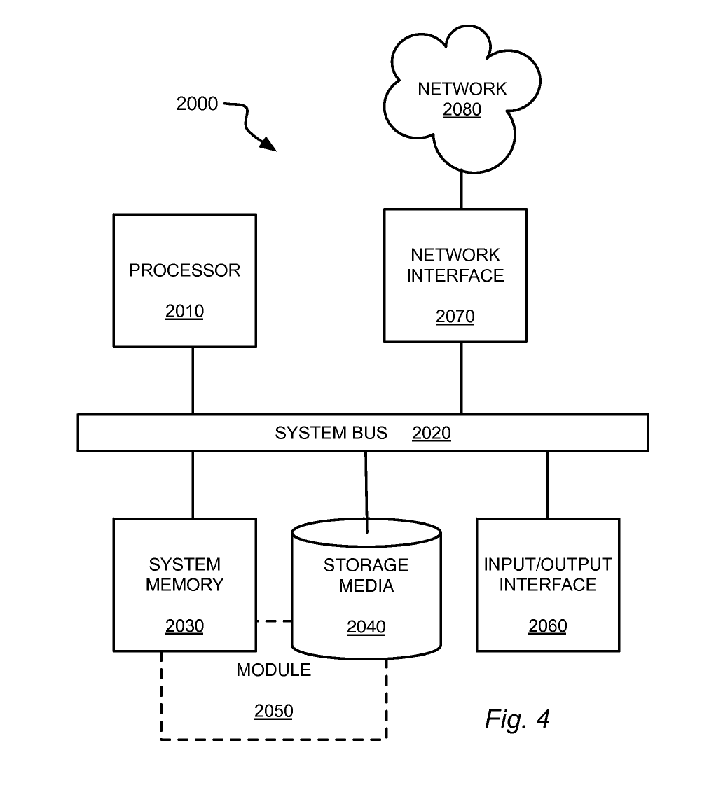

It should be appreciated that the user hardware 110, the offer provider 140, the hardware attestation server 160, and other computing machines associated with this technology may be any type of computing machine such as, but not limited to, those discussed in more detail with respect to FIG. 4. Furthermore, the server modules 170, any modules associated with the user hardware 110, any modules associated with the offer provider 140, or any other modules (software, firmware, or hardware) associated with the technology presented herein may by any of the modules discussed in more detail with respect to FIG. 4. The computing machines discussed herein may communicate with one another as well as other computer machines or communication systems over one or more networks such as network 150. The network 150 may be any of the network technology discussed with respect to FIG. 4.

The user hardware 110 may incorporate hardware identification information such as the unique identifier 120, the group identifier 130, or other such identification information. The hardware identification information may be embedded into the user hardware 110 during manufacture. While the hardware identification information may be erasable or rewritable, the hardware identification information may provide significantly stronger security when it is read-only. Read-only hardware identification information may be permanently and uniquely coupled to an instance of user hardware 110 and thus may provide stronger security benefits when used for security features such as validating offer enrollment, securing software licenses, or so forth.

The hardware identification information such as the unique identifier 120 or the group identifier 130 may be written, flashed, or burned into a basic input output system (“BIOS”), configuration complementary metal-oxide-semiconductor (“CMOS”), vital product data (“VPD”), firmware, read only memory, or other configuration or boot-strapping memory associated with the user hardware 110. A set of VPD may include configuration and informational data associated with a set of hardware, such as part numbers, serial numbers, and version numbers. It should be appreciated that the hardware identification information may be tightly associated with a computing machine itself, for example through the motherboard, firmware, or processor. Also, the hardware identification information may be associated with one or more peripherals, such as drives, memories, storage, network interfaces, or so forth. Furthermore, the hardware identification information may be combined from multiple sources associated with the motherboard, processor(s), peripherals, or may be virtualized within, or embedded into, one or more software modules associated with the user hardware 110.

The user hardware 110 may incorporate, or be associated with, an operating system 115 such as UNIX, LINUX, GOOGLE CHROME OS, MICROSOFT WINDOWS, APPLE OS X, and so forth. According to certain embodiments, the operating system 115 may provide functions for interacting with the hardware identification information such as the unique identifier 120, the group identifier 130, or any other such hardware information.

According to certain embodiments where the both the unique identifier 120 and the group identifier 130 are provided as part of the hardware identification information, the unique identifier 120 may be a code unique to that particular piece of hardware, while the group identifier 130 may be generalized to a set of hardware. For example, the set of a certain model of laptop that was manufactured in a certain batch or time frame may be given a common group identifier 130. The unique identifier 120 may be used to validate an offer enrollment when a stronger attestation is desired. For example, to validate that the enrollment request originates from a specific laptop, or other user hardware 110, that has not yet enrolled in the offer. In contrast the group identifier 130 may be used when an attestation that the request came from one of the many laptops, or other user hardware 110, of a certain group that may or may not have enrolled in the offer before.

According to one or more embodiments, an example process is outlined for the generation and insertion of hardware identification information during the manufacturing of the user hardware 110. A random or pseudo random seed of 128 bytes may be generated. A random or pseudo random key of 128 bytes may also be generated. According to other example embodiments, keys and seeds exceeding 128 bytes may be used for increased security. A randomizing function may be used to create an n-byte random number using the seed. A hash-based message authentication code (“HMAC”) may be computed over the n-byte random number. A cyclic redundancy check (“CRC”) such as a 32-bit CRC may be appended to the HMAC. Each resultant code may have 36 bytes in total and these codes may be placed into instances of user hardware 110 as hardware identification information. According to other example embodiments, longer codes may be used for increased security. Factory logs may be maintained as a white list of valid codes that have been created and perhaps also a black list of unused or discarded codes. These lists may be shared with the hardware attestation server 160 for validation of hardware identification information.

The offer provider 140 may comprise one or more computing machines such as web servers and database servers. The offer provider 140 may have offers available for enrollment by a user associated with the user hardware 110. These offers may include discounted or free goods or services. For example, the offers may be associated with the user hardware 110 such as free or discounted wireless network access, wireless access on airline flights, cloud storage, media streaming, technical support, software licenses, service licenses, and so forth. When the offer is associated with the user hardware 110, the validation technology discussed herein is particularly meaningful in tying the offer to use associated with the user hardware 110. The offer provider 140 may be assigned one or more service identifiers. The service identifiers may also be known to the hardware attestation server 160 and may be used to identify various services or offers that may be enrolled with the offer provider 140.

The hardware attestation server 160 may comprise one or more computing machines configured to provide private third party hardware validation and attestation. For example, the offer provider 140 can request that the hardware attestation server 160 validate the hardware identification information associated with the user hardware 110. The hardware attestation server 160 may be bound to a known network address, IP address, or domain name to simplify access to attestation services from various offer providers 140. The hardware attestation server 160 may be a trusted system.

According to certain embodiments, the hardware attestation server 160 may be related to the user hardware 110 and/or the associated operating system 115. For example, the same vendor or provider of the user hardware 110 and/or the associated operating system 115 may also operate, or be affiliated with, the hardware attestation server 160 in order to provide validation of hardware identification of its provided user hardware 110 to various offer providers 140.

The hardware attestation server 160 can maintain status information and statistics on various factors. The hardware attestation server 160 can maintain lists of the valid unique identifiers 120, group identifiers 130, and service identifiers. For each pair defined as (service identifier, unique identifier 120) or pair defined as (service identifier, group identifier 130), the hardware attestation server 160 may store the number of successful enrollments that have been made. For each service identifier, the hardware attestation server 160 may store the maximum number of enrollments allowed for each unique identifier 120 or group identifier 130. The maximum may be set individually by each offer provider 140 and in many cases may be one for a unique identifier 120 or N for a group identifier 130, where N is the size of associated group.

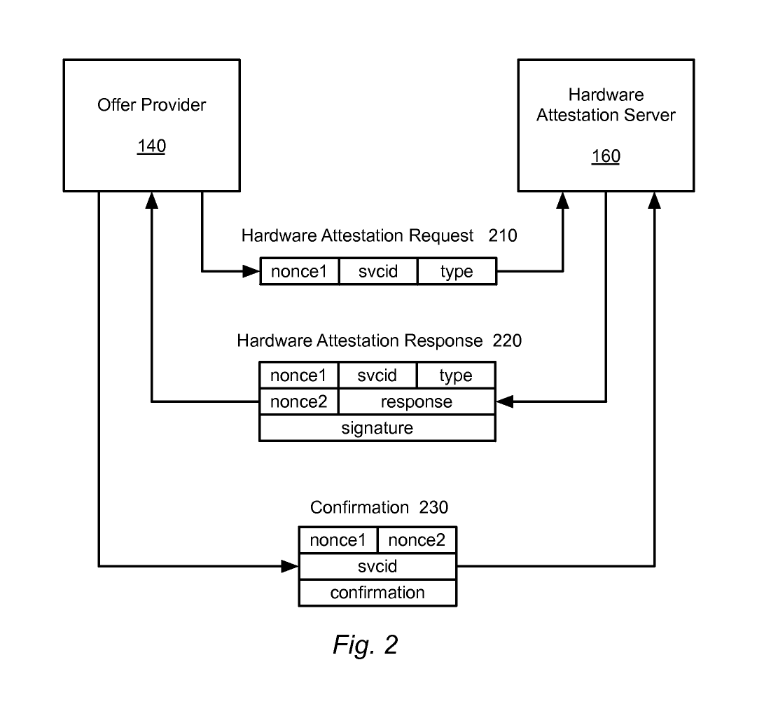

FIG. 2 is a block diagram depicting message structures used for private third party hardware identity validation in accordance with one or more embodiments presented herein.

A hardware attestation request 210 may be issued from the offer provider 140 to the hardware attestation server 160 to request a third party hardware validation. When a user associated with the user hardware 110 requests to initiate enrollment in an offer with the offer provider 140, the offer provider 140 may issue a hardware attestation request 210 to validate the user hardware 110. The hardware attestation request 210 may generally comprise at least three fields or pieces of information. Of course, the fields of the hardware attestation request 210 may, according to various embodiments, include a subset of these, a superset of these, or other similar or related fields. According to some embodiments, the fields may include any or all of a first nonce (“nonce1” as illustrated), a service identifier (“svcid” as illustrated), and a type indicator (“type” as illustrated).

The first nonce of the hardware attestation request 210 may be generated at the offer provider 140 as an indicator of this particular transaction. Generally, a nonce is an arbitrary number used “just once” and may be generated randomly or pseudo-randomly. When later responses or other messages are returned to the offer provider 140, those communications may be tied back to the original hardware attestation request 210 by matching the first nonce as originally provided by the offer provider 140.

The service identifier of the hardware attestation request 210 can uniquely indicate the service or offer that the user associated with the user hardware 110 is attempting to redeem or enroll into. The service identifier may be known at the hardware attestation server 160 as one of the service identifiers associated with the particular offer provider 140. An offer provider 140 may be associated with multiple service identifiers. Each of which may correspond to particular offers being providing by that offer provider 140.

The type indicator of the hardware attestation request 210 may be used to communicate the nature of the hardware attestation being requested by the offer provider 140 using the hardware attestation request 210. For example, the type may indicate if a weak or strong attestation is requested. In other examples, the type may indicate if an individual or group hardware identifier should be used for the validation.

Upon receiving the hardware attestation request 210, the hardware attestation server 160 may contact the under hardware 110 for validation of one or more pieces of hardware validation information associated with the user hardware 110. After this validation process, the hardware attestation server 160 may transmit a hardware attestation response 220 to the offer provider 140. The hardware attestation response 220 may generally comprise at least six fields or pieces of information. Of course, the fields of the hardware attestation response 220 may, according to various embodiments, include a subset of these, a superset of these, or other similar or related fields. According to one or more embodiments, the fields of the hardware attestation response 220 may include any or all of the first nonce, service identifier, and type indicator as discussed with respect to the example hardware attestation request 210. The fields of the hardware attestation response 220 may also include any or all of a second nonce (“nonce2” as illustrated), a response, and a signature.

The second nonce of the hardware attestation response 220 may be generated at the hardware attestation server 160 as an indicator of this particular transaction. When later confirmations or other messages are returned to the hardware attestation server 160, those communications may be tied back to the hardware attestation response 220 by matching the second nonce as provided by the hardware attestation server 160.

The response field of the hardware attestation response 220 may be generated at the hardware attestation server 160 as an indicator of success for the validation. According to one or more embodiments, the response field may take two different values such as true/false, pass/fail, yes/null, or so forth. For each pair, the positive response (true, pass, yes) can indicate that the user hardware 110 is eligible for enrollment in the requested offer. The negative (or neutral) response (false, fail, null) can indicate that the user hardware 110 is not eligible for enrollment in the requested offer. An advantage to providing a negative response as a more neutral null value is to output less information for possible attack. For example, the response may avoid distinguishing between causes of a negative response. Without specifying why, a negative response may simply be negative (or neutral).

The response field of the hardware attestation response 220 may be negative (or neutral) due to a few different example scenarios. One example that may cause a negative response is when the user hardware 110 did not provide its hardware identification information upon request from the hardware attestation server 160. Another example that may cause a negative response is when the user hardware 110 provides hardware identification information that does not meet the list of hardware identifiers qualified for the requested offer. Another example that may cause a negative response is when the hardware identification information provided by the user hardware 110 has already been enrolled for the maximum number of instances for the requested service identifier.

The offer provider 140 may use the signature field of the hardware attestation response 220 to verify the source and contents of the hardware attestation response 220. The signature may be verifiable using a public key already known to the offer provider 140. The signature may be computed over some or all of the other fields of the hardware attestation response 220

Upon receiving a positive hardware attestation response 220, the offer provider 140 may continue the offer enrollment process for the user associated with the user hardware 110. After this enrollment process, the offer provider 140 may transmit a confirmation 230 to the hardware attestation server 160. The confirmation may close the loop with the hardware attestation server 160 for record keeping purposes. The confirmation 230 may generally comprise at least four fields or pieces of information. Of course, the fields of the confirmation 230 may, according to various embodiments, include a subset of these, a superset of these, or other similar or related fields. According to one or more embodiments, the fields of the confirmation 230 may include any or all of the first nonce, the second nonce, the service identifier (“svcid” as illustrated), and a confirmation field.

The first nonce and second nonce may be used as indicators of the particular transaction. The confirmation 230 may be tied to other communications associated with a transaction by matching the first nonce and the second nonce to those generated by the offer provider 140 and the hardware attestation server 160. Identification of the transaction by its nonce values can assist in not including the hardware identifiers in any of the communications with the offer provider 140. As such, the offer provider 140 may never see any specific indicators of the user hardware 110 or the associated hardware identification information such as the unique identifier 120, the group identifier 130, or any other hardware identifiers.

The confirmation 230 can inform the hardware attestation server 160 to update its counters and records associated with the enrolled service identifier. The counters at the hardware attestation server 160 that are maintained in terms of the hardware identification information (such as unique identifier 120 or group identifier 130) may store the accounting, privileges, or other information in terms of versions of the hardware identifiers that are hashed or otherwise coded so as to further protect the privacy of any hardware identification information

The hardware attestation request 220, hardware attestation response 220, confirmation 230, and any other messages or communications associated with this technology may be passed through one or more networks using hypertext transfer protocol secure (“HTTPS”). The hardware attestation server 160 may be located at a well-known domain or network address. The hardware attestation server 160 may user public key pinning. The hardware attestation server 160 can also maintain a known or registered list of offer providers 140 and their domain name or network addresses to ensure that hardware attestation may only be performed for approved providers.

There may be various other privacy features of the techniques disclosed herein. The offer provider 140 may never received any specific information about the user hardware 110 (including the hardware identification information). As such, the offer provider 140 cannot track the user hardware 110 based on its hardware identification information. The hardware attestation server 160 may be prevented form tacking any other operations of the offer provider 140. The hardware attestation server 160 may only be involved during initial enrollment. Subsequent usage of the service by the user hardware 110 may never require additional transactions involving the hardware attestation server 160. The hardware attestation server 160 may be prevented form correlating or tracking any account information, cookies, or so forth with the hardware identification information.

With the most basic protocol implementation, an error during the validation may lead to the user seeing a browser error page. According to certain more sophisticated protocol embodiments, the user hardware 110 (or associated operating system 115 or other modules) may create a secure session that may only be accessed by a domain or address associated with the offer provider 140. For example, a secure cookie session may be created with the cookie value being set to the attestation response. Also, the offer provider 140 may use website use an “offers intent” to indicate interest in determining if a certain user hardware 110 is eligible for an offer.

### System Process

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

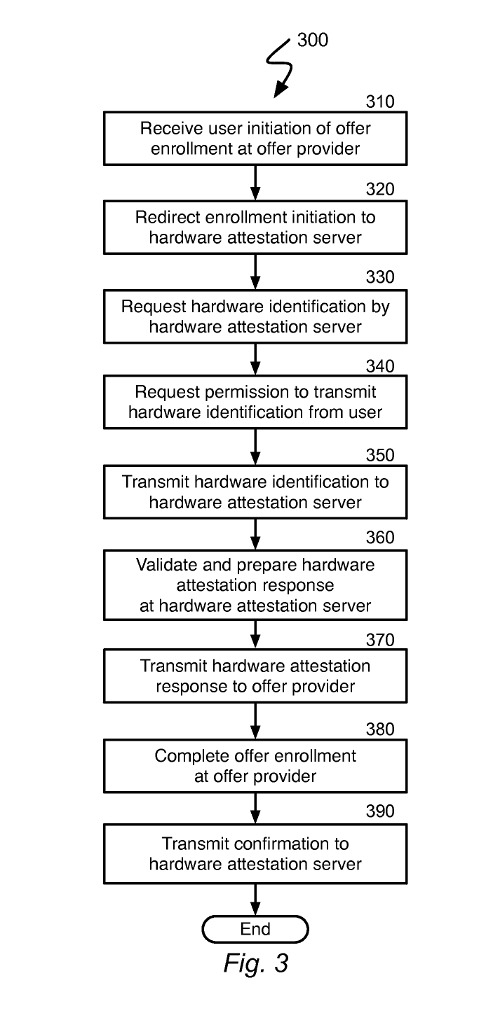

FIG. 3 is a block flow diagram depicting a method 300 for private third party validation of hardware identification in accordance with one or more embodiments presented herein.

In block 310, a user associated with the user hardware 110 may initiate redemption or offer enrollment. This enrollment initiation may issue from the user hardware 110 to the offer provider 140. For example, the user may navigate to a website associated with the offer provider 140 and indicate interest in redeeming or enrolling in an offer.

In block 320, the enrollment initiation may be redirected from the offer provider 140 to the hardware attestation server 160. The redirected enrollment initiation may incorporate a hardware attestation request 210. The hardware attestation request 210 may include a service identifier to specify the service into which enrollment is being requested. The hardware attestation request 210 may also include a first nonce.

In block 330, the hardware attestation server 160 can request hardware identification information from the user hardware 110 to be validated. The hardware attestation server 160 may issue this request to the user hardware 110 using an application programming interface (“API”). The API may be pinned to a domain associated with the hardware attestation server 160. According to one or more embodiments, the APL may be a JavaScript API. The hardware attestation server 160 may issue the request for hardware identification information to the operating system 115 associated with the user hardware 110. This participation of the operating system 115 in hardware identification validation may be particularly meaningful where the operating system 115 may be coupled with the hardware attestation server 160.

In block 340, the operating system 115 may prompt the user of the user hardware 110 for permission to share hardware identification information with the hardware attestation server 160. The hardware identification information associated with the user hardware 110 may include the unique identifier 120, the group identifier 130, or other such identification information. The prompt to the user may inform the user that sharing hardware identification information with the hardware attestation server 160 may be required to enroll in the requested offer. The prompt to the user may inform or remind the user that hardware identification information shared with the hardware attestation server 160 may be protected at the hardware attestation server 160 and thus not shared with the offer provider 140. It should be appreciated that this block may be excluded from certain embodiments, particular those where the operating system 115 may not be coupled with the hardware attestation server 160.

In block 350, the hardware identification information may be transmitted from the operating system 115 associated with the user hardware 110 to the hardware attestation server 160. This transfer may be contingent upon user approval from block 340. The hardware identification information associated with the user hardware 110 may include the unique identifier 120, the group identifier 130, or other such identification information.

An API (such as a JavaScript API) may hook into the operating system 115 or an associated module or daemon to provide access to the hardware identification information. Since the flash memory, or other VPD storage memory may introduce a delay in reading the hardware identification information, the operating system 115, daemon, or other module may cache the hardware identification information.

The hardware identification information may be wrapped, encrypted, or otherwise transformed to avoid capture, “man in the middle” exploits, or other security attacks. It should be appreciated that this block may be excluded from certain embodiments, particular those where the operating system 115 may not be coupled with the hardware attestation server 160.

In block 360, a hardware attestation response 220 may be prepared by the hardware attestation server 160. The hardware attestation response 220 may indicate whether or not enrollment is being approved by the hardware attestation server 160. For example, enrollment may be approved by the hardware attestation server 160 in response to receiving a unique identifier 120 or a group identifier 130 from the user hardware 110 that has not yet exhausted its allocated offer enrollment.

In block 370, the hardware attestation server 160 can transmit the hardware attestation response 220 to the offer provider 140. The hardware attestation response 220 may include the parameters from the original hardware attestation request 210. The hardware attestation response 220 may also include a second nonce and an affirmative or negative affirmation indicator. The hardware attestation response 220 may also include a signature. It should be appreciated that neither the unique identifier 120 nor the group identifier 130 are incorporated into the hardware attestation response 220. Since the hardware attestation response 220 is being delivered to the offer provider 140, hardware identifiers associated with the user hardware 110 are not to be included. The offer provider 140 can identify the hardware attestation response 220 with the correct hardware attestation request 210 according to the first nonce.

In block 380, the offer provider 140 can complete the enrollment initiated in block 310 in response to receiving an affirmative attestation from the hardware attestation server 160. Completion of enrollment may include, for example, guiding the user association with the user hardware 110 through a registration process.

In block 390, the offer provider 140 can transmit a confirmation 230 to the hardware attestation server 160. The confirmation 230 may be sent after successful completion of the enrollment in block 380. The confirmation 230 can inform the hardware attestation server 160 to update counters and records associated with the enrolled service identifier.

After block 390, the method 300 ends. Of course, hardware validations performed by the hardware attestation server 160 may be continued through repeated application of method 300.

### General

FIG. 4 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of the embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for validating computer hardware identification information, the method comprising:
receiving, by one or more computing devices, a request from an offer provider computer system to validate an instance of user hardware for enrollment in an offer associated with a service identifier;
requesting, by the one or more computing devices, a hardware identification from the instance of user hardware;
receiving, by the one or more computing devices, the hardware identification from the instance of user hardware;
validating, by the one or more computing devices, that the hardware identification is eligible to enroll in the offer associated with the service identifier;
generating, by the one or more computing devices, a validation status in response to validating the hardware identification; and
transmitting, by the one or more computing devices, a response to the offer provider computer system indicating the validation status without providing the hardware identification to the offer provider computer system.

2. The computer-implemented method of claim 1, wherein the hardware identification is written into the instance of user hardware during a manufacturing process.

3. The computer-implemented method of claim 1, wherein the hardware identification comprises one of a unique identifier, a group identifier, and a vital product datum.

4. The computer-implemented method of claim 1, wherein generating the validation status comprises verifying that at least one offer associated with the service identifier is unclaimed.

5. The computer-implemented method of claim 1, wherein the request from the offer provider to validate the instance of user hardware is a redirection of a request from a user of the instance of user hardware to initiate enrollment with the offer provider.

6. The computer-implemented method of claim 1, further comprising decrementing a number of remaining ones of the offer associated with the service identifier in response to receiving a confirmation associated with the response.

7. The computer-implemented method of claim 1, wherein requesting the hardware identification from the instance of user hardware comprises receiving approval from a user of the instance of user hardware to transmit the hardware identification.

8. The computer-implemented method of claim 1, wherein enrollment in the offer comprises requesting to receive a free or discounted good or service.

9. A system for enrolling in offers based upon hardware identification, the system comprising:
one or more processors;
an embedded hardware identification; and
a memory having embedded therein computer-readable instructions that when executed by the one or more processors cause the one or more processors to:
initiate enrollment with an offer provider;
receive a request for hardware identification from a third party hardware identification server;
read identifier content from the embedded hardware identification; and
transmit the identifier content to the third party hardware identification server.

10. The system of claim 9, wherein the embedded hardware identification is written during manufacturing.

11. The system of claim 9, wherein the embedded hardware identification comprises a non-erasable memory.

12. The system of claim 9, wherein the embedded hardware identification comprises one or more of a unique identifier, a group identifier, and vital product data.

13. The system of claim 9, wherein the one or more modules are further operable to query a user for approval to transmit the identifier content.

14. The system of claim 9, wherein privacy of the embedded hardware identification is maintained by the third party hardware identification server from the offer provider.

15. A computer program product, comprising:
a non-transitory computer-readable medium having computer-readable program code embodied therein that, when executed by one or more computers, perform a method comprising:
initiating enrollment in an offer with an offer provider;
receiving a request for hardware identification from a third party hardware identification server to authorize enrollment in the offer;
reading identifier content from an embedded hardware identification;
transmitting the identifier content to the third party hardware identification server; and
maintaining privacy of the identifier content from the offer provider.

16. The computer program product of claim 15, wherein the embedded hardware identification is written into an instance of hardware during manufacturing.

17. The computer program product of claim 15, wherein the embedded hardware identification comprises a non-erasable memory.

18. The computer program product of claim 15, wherein the identifier content comprises one or more of a unique identifier, a group identifier, and vital product data.

19. The computer program product of claim 15, wherein the method further comprises querying a user for approval to transmit the identifier content.

20. The computer program product of claim 15, wherein the third party hardware identification server is accessed at a specified network address.
